(19) United States
(12) Patent Application Publication
(10) Pub. No.: US 2003/0016818 A1
(43) Pub. Date: Jan. 23, 2003

(54) Telephone line adapter

(76) Inventor: Mao Jen Kuo, Tainan (TW)

Correspondence Address: Keith Kline, PRO-TECHTOR INTERNATIONAL SERVICES, 20775 Norada Court, Saratoga, CA, 95070-3018, US

(21) Appl. No.: 09/908,080

(22) Filed: Jul. 17, 2001

(51) Int. Cl. H04M 1/00; H04M 9/00

(52) U.S. Cl. 379/446; 379/437

(57) ABSTRACT

A telephone adapter includes a spool mounted in a casing and controlled by a winding spring in the casing to take up a telephone line, which extends out of the casing for connection to the handset or phone base of a telephone, a module jack disposed in a hole on the casing and electrically connected to the telephone line by two annular metal contact elements and two metal contact springs and adapted to receive an external telephone module plug, a lock and automatic rewind switch, and a locking mechanism controlled by the lock and automatic rewind switch to lock/unlock the spool.

### BACKGROUND OF THE INVENTION

The present invention relates to a telephone line adapter and, more particularly, to a telephone line adapter that can be connected between the exchange line and the telephone system to extend the working distance between the exchange line and the telephone system.

After the installation of a telephone, the telephone cannot be moved out of place over a predetermined distance (equal to the length of the telephone line connected between the phone base of the telephone and the module jack of the exchange line in the wall). Further, because the telephone cord of a telephone has a limited length, the user must be within a limited distance from the phone base of the telephone when picking up the handset to make or receive a call.

### SUMMARY OF THE INVENTION

The present invention has been accomplished under the circumstances in view. It is one object of the present invention to provide a telephone line adapter, which can be used to extend the working distance between the exchange line and a telephone. It is another object of the present invention to provide a telephone line adapter, which can be used to extend the working distance between the phone base and handset of a telephone. It is still another object of the present invention to provide a telephone line adapter, which can be controlled to take up the telephone line automatically. According to one aspect of the present invention, the telephone adapter comprises a spool mounted in a casing and controlled by a winding spring in the casing to take up a telephone line, which extends out of the casing for connection to the handset or phone base of a telephone, a module jack disposed in a hole on the casing and electrically connected to the telephone line by two annular metal contact elements and two metal contact springs and adapted to receive an external telephone module plug, a lock and automatic rewind switch, and a locking mechanism controlled by the lock and automatic rewind switch to lock/unlock the spool. According to another aspect of the present invention, a telephone line positioning structure is fastened to one end of the telephone line adapted to stop the outer end of the casing the winding spring is released to drive the spool to take up the telephone line.

### BRIEF DESCRIPTION OF THE DRAWINGS

FIG. 1 is an exploded view of a telephone line adapter according to the present invention.

FIG. 2 is a top plain view of the telephone line adapter according to the present invention.

FIG. 3 is similar to FIG. 2 but showing the stop bar disengaged from the sloping teeth of the spool, the spool turned about the keeper, the telephone line moved in and out of the cover shells.

FIG. 4 is a side view in section of the present invention showing the telephone line adapter operated (I).

FIG. 5 is a side view in section of the present invention showing the telephone line adapter operated (II).

FIG. 6 illustrates the arrangement of the telephone line positioning structure in the telephone line adapter according to the present invention.

FIG. 7 is an exploded view in sectional elevation of the telephone line positioning structure according to the present invention.

FIG. 8 is an installed view in section of the telephone line positioning structure according to the present invention (Step 1).

FIG. 9 is an installed view in section of the telephone line positioning structure according to the present invention (Step II).

FIG. 10 is a sectional view of an alternate form of the telephone line positioning structure according to the present invention.

FIG. 11 shows one application example of the present invention.

FIG. 12 shows another application example of the present invention.

### DETAILED DESCRIPTION OF THE PREFERRED EMBODIMENT

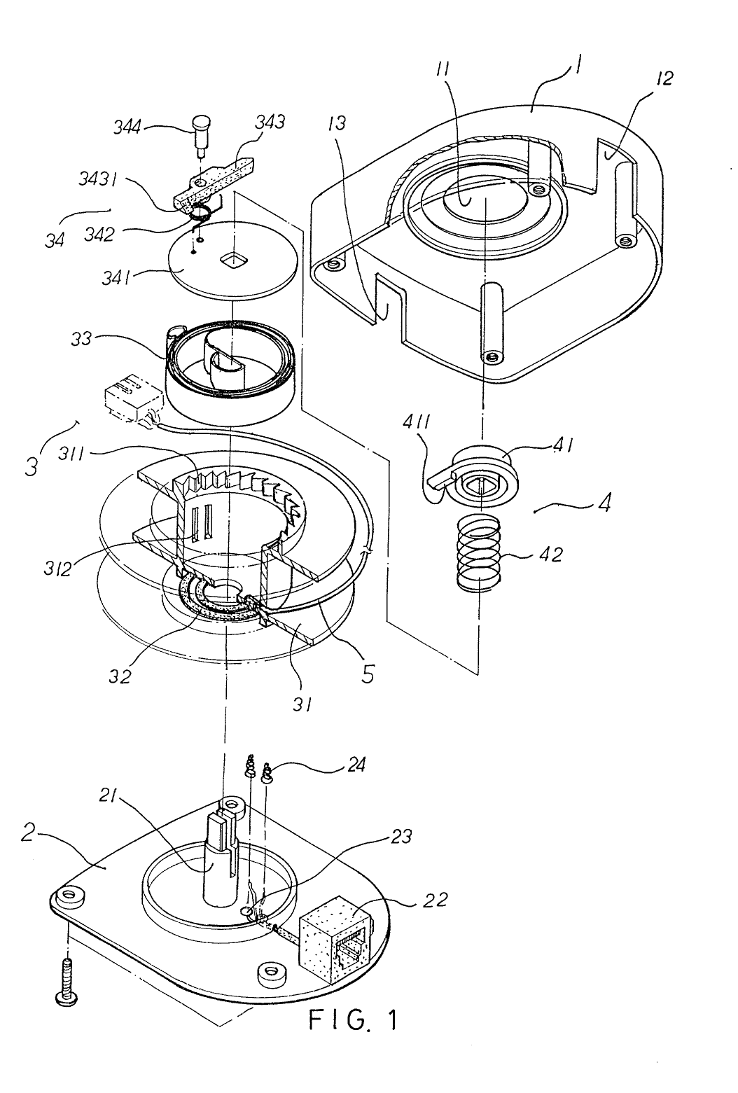

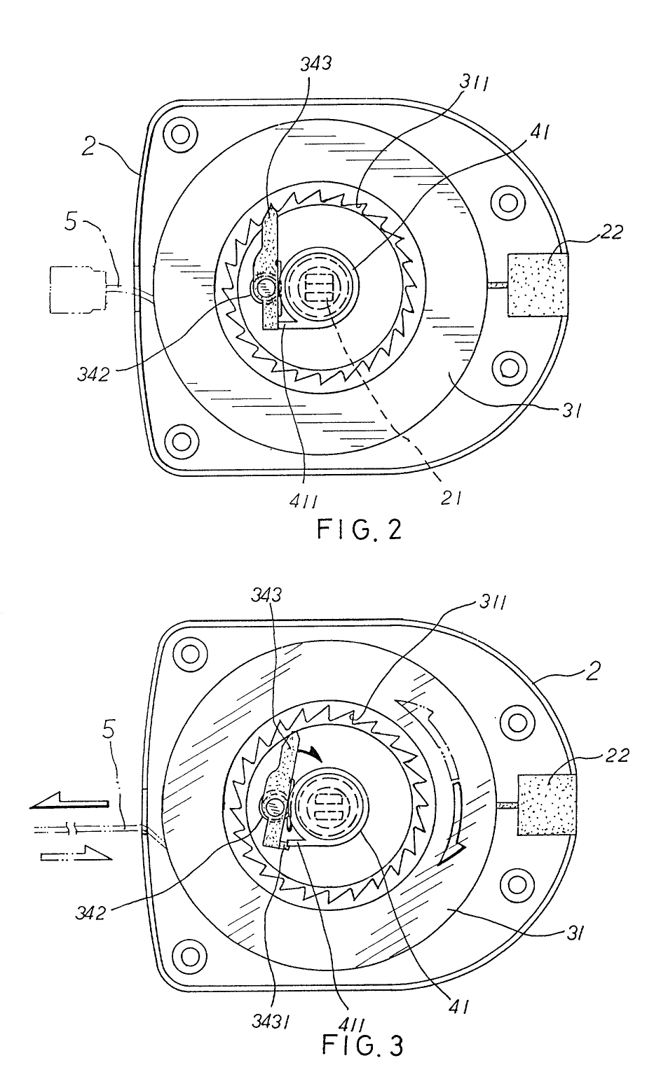

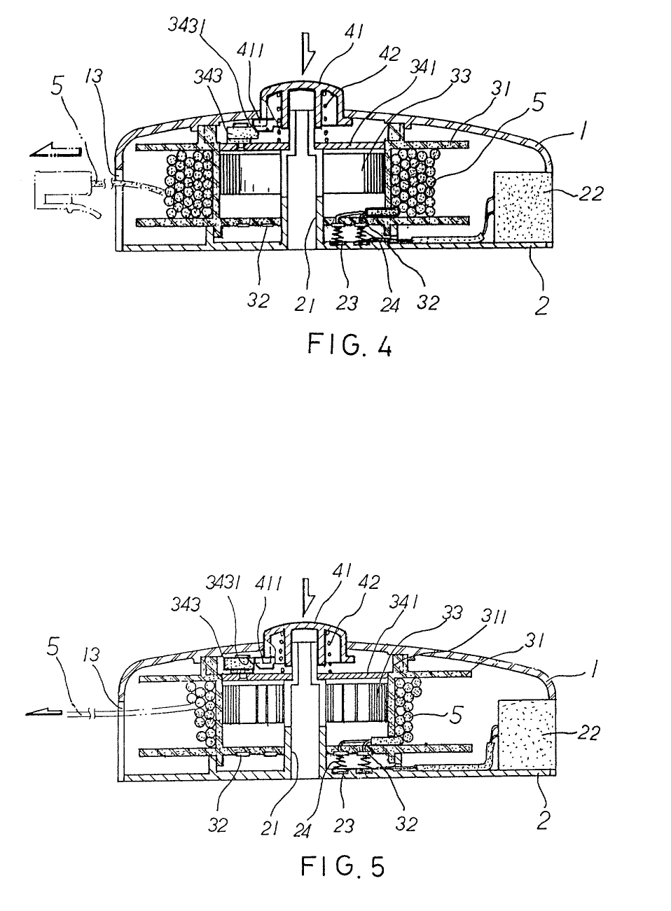

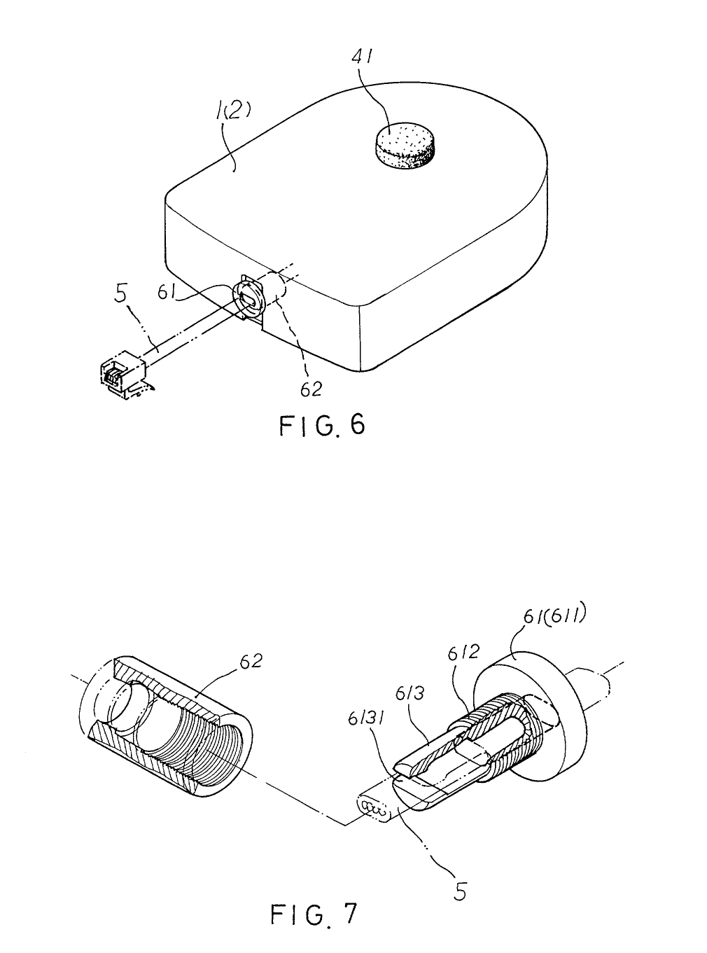

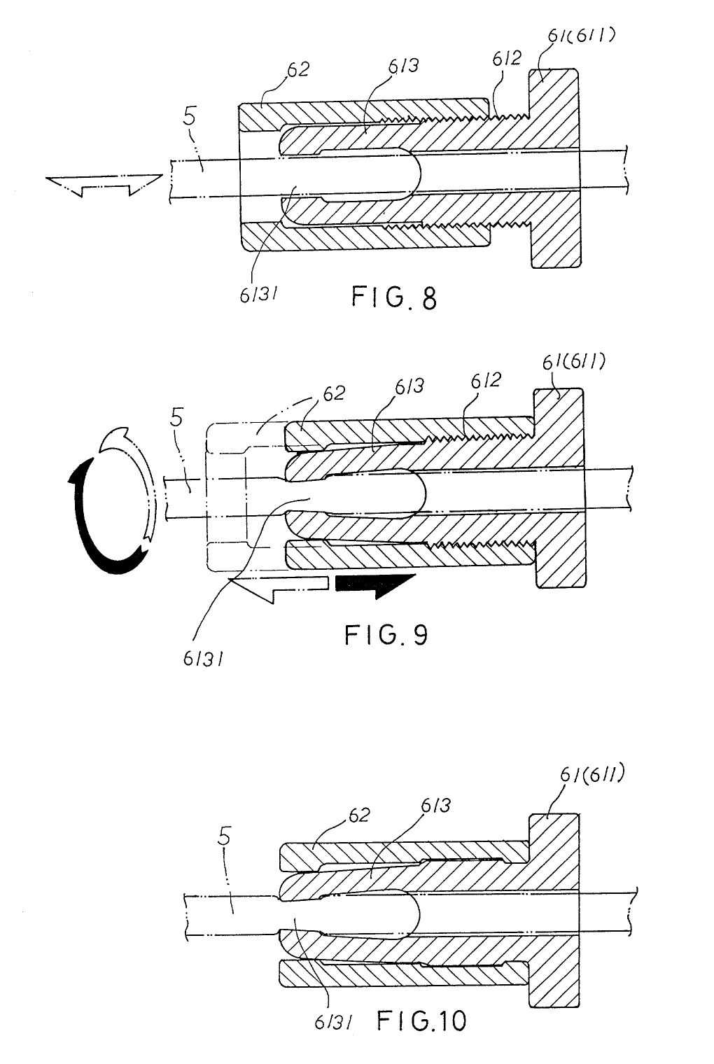

Referring to FIGS. 1 and 2, a telephone line adapter in accordance with the present invention is shown comprised of a top cover shell 1, a bottom cover shell 2, a winding unit 3, and a lock and automatic rewind switch 4.

The top cover shell 1 is covered on the bottom cover shell 2 to hold the other component parts of the telephone line adapter on the inside, comprising a top center hole 11, a first peripheral notch 12, and a second peripheral notch 13 opposite to the first peripheral notch 13. The bottom cover shell 2 comprises a keeper 21 upwardly extended from the top sidewall thereof, a telephone module jack 22 disposed corresponding to the first peripheral notch 12 of the top cover shell 1 and adapted to receive telephone module plug, two wire grooves 23 extended from the module jack 22 toward the keeper 21, and two metal contact springs 24 respectively installed in the wire grooves 23 near the keeper 21 and respectively electrically connected to the positive and negative terminals of the module jack 22. The winding unit 3 comprises a spool 31, two annular metal contact elements 32, a winding spring 33, and a locking mechanism 34. The annular metal contact elements 32 are concentrically fixedly fastened to one side, namely, the bottom side of the spool 31 corresponding to the metal contact springs 24. The spool 31 is coupled to the keeper 21, keeping the annular metal contact elements 32 in contact with the metal contact springs 24 respectively. The winding spring 33 and the locking mechanism 34 are respectively mounted in the inner diameter of the spool 31. The spool 31 comprises a series of sloping teeth 311 arranged along the inner diameter near the topside thereof, and at least one retaining hole 312 in the inner diameter below the sloping teeth 311. The winding spring 33 has one end, namely, the inner end fastened to the keeper 21, and the other end, namely, the outer end fastened to one retaining hole 312 of the spool 31. Rotating the spool 31 on the keeper 21 causes the winding spring 33 to be tightened or released. The locking mechanism 34 comprises a flat board 341, a spring 342, a stop bar 343, and a pivot pin 344. The flat board 341 is mounted in the inner diameter of the spool 31 above the winding spring 33 and fixedly fastened to the keeper 21. The pivot pin 344 is fixedly vertically fastened to the flat board 341 at the top. Alternatively, the pivot pin 344 can be formed integral with the top sidewall of the flat board 341. The stop bar 343 is turned about the pivot pin 344, having one end forced into engagement with the sloping teeth 311 of the spool 31 and the other end terminating in beveled nose 3431. The spring 342 is mounted on the pivot pin 344 between the flat board 341 and the stop bar 343 to force the stop bar 343 into engagement with the sloping teeth 311 of the spool 31, having one end fastened to the stop bar 343 and the other end fastened to the flat board 341. The lock and automatic rewind switch 4 is comprised of a switch button 41 and a coil spring 42. The switch button 41 is coupled to the top end of the keeper 21 and partially inserted through the top center hole 11 of the top cover shell 1 from the inside of the top cover shell 1 toward the outside, having a beveled stop rod 411 extended from the periphery and disposed in contact with the beveled nose 3431 of the stop bar 343. The spring 42 supports the switch button 41 on the flat board 341.

Referring to FIGS. from 2 through 5, when pressing on the switch button 41, the beveled stop rod 411 is forced against the beveled nose 3431 of the stop bar 343, thereby causing the stop bar 343 to be disengaged from the sloping teeth 311 of the spool 31. On the contrary, when pressing off the switch button 41, the spring 42 forces the switch button 41 upwards to release pressure from the stop bar 343, enabling the stop bar 343 to be forced into engagement with the sloping teeth 311 of the spool 31 by the spring 342 again.

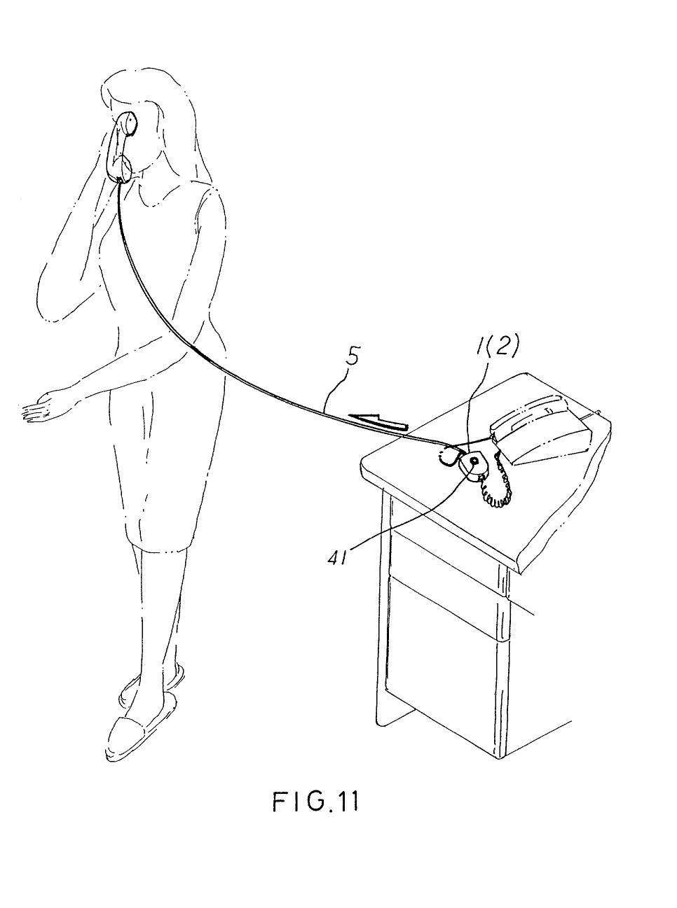

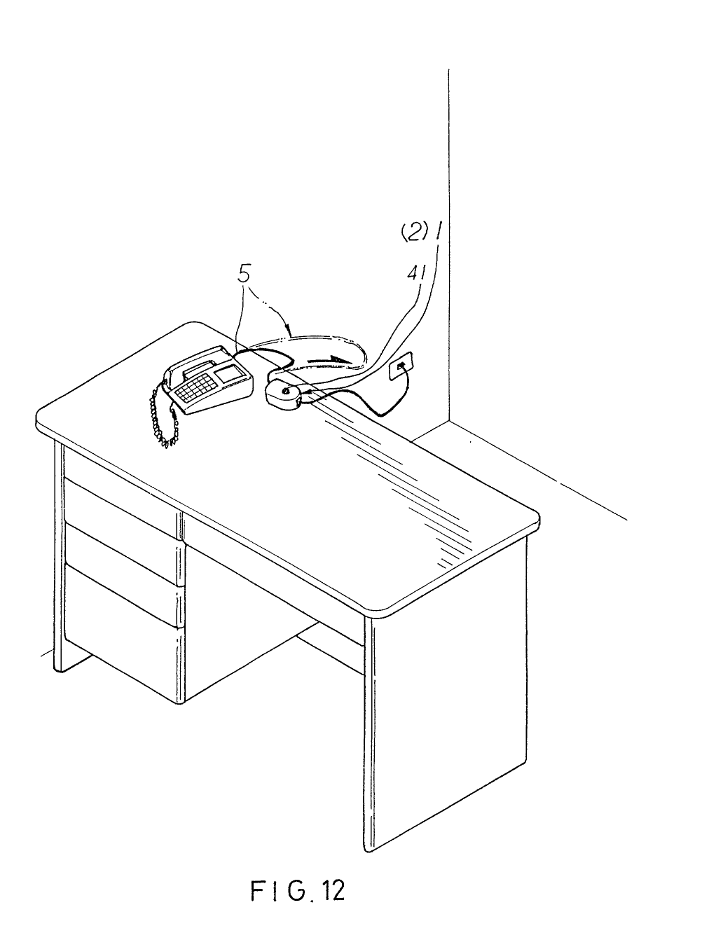

During installation, the telephone line adapter is mounted with a telephone line 5 and connected between the handset cord and handset of a telephone. The telephone line 5 is wound round the spool 31, having one end electrically connected to the annular metal contact elements 32 and the other end (the end with the module plug) extended out of the second peripheral notch 13 of the top cover shell 1 and connected to the telephone module jack of the handset of the telephone (see FIG. 11).

Referring to FIGS. from 3 through 5 again, when pressing on the switch button 41, the beveled stop rod 411 is forced against the beveled nose 3431 of the stop bar 343, thereby causing the stop bar 343 to be disengaged from the sloping teeth 311 of the spool 31 for enabling the spool 31 to be rotated on the keeper 21 (see FIG. 3), and thus the user can pull the telephone line 5 out of the telephone line adapter to the desired distance (see FIG. 11). When releasing the pulling force from the telephone line 5, the winding spring 33 automatically moves the spool 31 to take up the telephone line 5. After the telephone line 5 has been received, the switch button 41 is pressed off, and at this time the spring 42 forces the switch button 41 upwards to release pressure from the stop bar 343, enabling the stop bar 343 to be forced into engagement with the sloping teeth 311 of the spool 31 by the spring 342 again.

Referring to FIGS. from 6 through 9, a telephone line positioning structure 6 is provided and adapted to stop the telephone line 5 from being completely received inside the cover shells 1;2. The telephone line positioning structure 6 is comprised of a collar 61 and a chuck sleeve 62. The collar 61 is a hollow cylindrical member of T-shaped profile mounted on the telephone line 5 outside the cover shells 1;2, comprising a rear expanded section 611 of diameter greater than the second peripheral notch 13, a front clamping section 613, and a middle threaded section 612 axially connected between the rear expanded section 611 and the front clamping section 613. The front clamping section 613 has longitudinal splits 6131. The chuck sleeve 62 is threaded onto the middle threaded section 612 of the collar 61 to force the split front clamping section 613 radially inwards against the periphery of the telephone line 5. When taking up the telephone line 5, the rear expanded section 611 of the collar 61 will be stopped out side the second peripheral notch 13 of the top cover shell 1, preventing the telephone line 5 from being completely received inside the cover shells 1;2. Further, in an alternate form of the telephone line positioning structure 6, the chuck sleeve 62 is axially forced into engagement with the periphery of the collar 61 by squeezing, i.e., no screw joint is provided for engagement between the collar 61 and the chuck sleeve 62 (see FIG. 10).

In the application example shown in FIG. 11, the telephone line adapter is connected between the phone base and handset of a telephone. Alternatively, the telephone line adapter can be connected between the phone base of a telephone and the exchange line as shown in FIG. 12.

A prototype of telephone line adapter has been constructed with the features of FIGS. 1˜9. The telephone line adapter functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A telephone line adapter comprising:
A bottom cover shell, said bottom cover shell comprising a keeper upwardly extended from a top sidewall thereof, a telephone module jack near the border thereof and adapted to receive a telephone module plug, two wire grooves extended from said module jack toward said keeper, and two metal contact springs respectively installed in said wire grooves and respectively electrically connected to positive and negative terminals of said module jack;
a top cover shell covered on said bottom cover shell, said top cover shell comprising a top center hole, a first peripheral notch, which receives the telephone module jack of said bottom cover shell, and a second peripheral notch opposite to said first peripheral notch;
a winding unit mounted on said keeper of said bottom cover shell inside said top cover shell, said winding unit comprising a hollow spool mounted on said bottom cover shell for turning about said keeper, said spool comprising a series of sloping teeth arranged along an inner diameter thereof and at least one retaining hole in the inner diameter below said sloping teeth, two annular metal contact elements, concentrically fixedly fastened to a bottom side of said spool and disposed in contact with the metal contact springs of said bottom cover shell, a winding spring mounted in said spool for driving said spool to take up said telephone line, said winding spring having an inner end fastened to said keeper and an outer end fastened to one retaining hole of said spool, a telephone line wound round said spool, said telephone line having one end electrically connected to said annular metal contact elements and an opposite end extended out of the second peripheral notch of said top cover shell, and a locking mechanism adapted to stop said spool from rotation relative to said keeper, said locking mechanism comprising a flat board fixedly fastened to said keeper and suspended in the inner diameter of said spool, a pivot pin upwardly extended from a top sidewall of said flat board, a stop bar turned about said pivot pin, said stop bar having a fist end adapted to engage the sloping teeth of said spool and a second end terminating in a beveled nose, a spring mounted on said pivot pin and connected between said flat board and said stop bar to force said stop bar into engagement with the sloping teeth of said spool; and
a lock and auto-rewind switch adapted to lock/unlock said locking mechanism, said lock and automatic rewind switch comprising a switch button coupled to said keeper and partially inserted through the top center hole of said top cover shell and adapted to disengage said stop bars of said winding unit from the sloping teeth of said spool, said switch button having a beveled stop rod extended from the periphery thereof and disposed in contact with the beveled nose of said stop bar, and a spring supporting said switch button on said flat board.

2. The telephone line adapter of claim 1 further comprising a telephone line positioning structure fastened to an outer end of said telephone line and adapted to stop the outer end of said telephone line outside the second peripheral notch of said top cover shell when said winding spring drives said spool to take up said telephone line.

3. The telephone line adapter of claim 2 wherein said telephone line positioning structure comprises a collar mounted on said telephone line and disposed outside said bottom cover shell and said top cover shell, said collar having a rear expanded section of diameter greater than the second peripheral notch of said top cover shell, a split front clamping section, and a middle engagement section axially connected between said rear expanded section and said front clamping section, and a chuck sleeve fastened to the middle engagement section of said collar and compressed on the front clamping section of said collar against the periphery of said telephone line.

4. The telephone line adapter of claim 3 wherein said chuck sleeve is fastened to the middle engagement section of said collar by a screw joint.

5. The telephone line adapter of claim 1 wherein said pivot pin of said locking mechanism of said winding unit is formed integral with the top sidewall of said flat board of said locking mechanism.
